(19) United States
(12) Patent Application Publication
(10) Pub. No.: US 2006/0134327 A1
(43) Pub. Date: Jun. 22, 2006

(54) Pretreatment method for coating surface of metal for vehicle chassis and method of applying powder coating composition

(75) Inventors: Kazuhiro Makino, Shinagawa-ku (JP); Aki Hashimoto, Shinagawa-ku (JP); Masanobu Futsuhara, Shinagawa-ku (JP); Toshiaki Shimakura, Shinagawa-ku (JP); Takehiko Kobayashi, Hino-shi (JP); Eikou Murakami, Hino-shi (JP)

Correspondence Address: CONNOLLY BOVE LODGE & HUTZ LLP, SUITE 800, 1990 M STREET NW, WASHINGTON, DC, 20036-3425, US

(73) Assignees: Nippon Paint Co., Ltd., Osaka-shi (JP); Hino Motors, Ltd., Tokyo (JP)

(21) Appl. No.: 11/295,475

(22) Filed: Dec. 7, 2005

(30) Foreign Application Priority Data
Dec. 8, 2004 (JP) 2004-355455

(51) Int. Cl. B05D 1/12; B05D 3/00

(52) U.S. Cl. 427/180; 427/299

(57) ABSTRACT

It is an object of the present invention to provide a pretreatment method for coating the surface of metal for vehicle chassis, in which a phosphorus element is not essential, the formation of sludge is extremely small, waste water treatment is facilitated, and a chemical conversion coat having adequate adhesion and adequate corrosion resistance can be formed. A pretreatment method for coating a surface of metal for vehicle chassis comprising treating the surface of metal for vehicle chassis with a chemical conversion treating solution to form a chemical conversion coat, wherein said chemical conversion treating solution comprises zirconium in an amount of 50 to 500 ppm on the metal element equivalent basis, and at least one silane compound selected from the group consisting of γ-aminopropyltriethoxysilane, hydrolysates of γ-aminopropyltriethoxysilane, γ-aminopropyltrimethoxysilane and hydrolysates of γ-aminopropyltrimethoxysilane; and has a pH of 2 to 6.

### TECHNICAL FIELD

The present invention relates to a pretreatment method for coating the surface of metal for vehicle chassis and a method of applying a powder coating composition.

### BACKGROUND ART

Vehicle chassises are generally constructed of a steel lumber such as a hot rolled steel lumber, a steel lumber from which a modified layer such as mill scale or the like is removed by shot blasting or the like, and in their coating, powder coating is performed after chemical conversion treatment by zinc phosphate treating agents. As such a pretreatment method for coating the surface of metal for vehicle chassis, there are known treatment methods by such treating agents as described in Japanese Kokai Publications Hei-10-204649 and 2002-220678.

In Japanese Kokai Publication Hei-10-204.649, there is disclosed an aqueous zinc phosphate solution which can form a coat having good adhesion of coating and good corrosion resistance even though omitting a surface conditioning step by containing specific components such as a phosphate ion, a zinc ion, a hydroxylamine source and the like in specific amounts, and a chemical conversion treatment method using this solution.

In Japanese Kokai Publication 2002-220678, there is disclosed a method of treating hot rolled steel sheets or steel lumber with a zinc phosphate treating agent containing specific components such as a phosphate ion, a zinc ion, a manganese ion, a nickel ion and the like in specific amounts to give a good corrosion resistance.

However, the zinc phosphate treating agent does not have good economy and good workability in waste water treatment because it has a high metal ion concentration and a high acid concentration and a extremely reactive treating agent. Further, as a result of the metal surface treatment with the zinc phosphate treating agent, water-insoluble salts are produced and deposited as a precipitate. Such a precipitate is generally referred to as sludge and considered to have a problem of the cost for removing and disposing of such sludge. Since a phosphate ion may burden the environment by eutrophication, it takes efforts to treat liquid waste and therefore it is preferred not to use it. Further, in the metal surface treatment with the zinc phosphate treating agent, a surface conditioning step is required, and which is a problem that the total process becomes long.

As a metal surface treating agent other than the zinc phosphate treating-agent, there are described metal surface treating agents comprising a zirconium compound in Japanese Kokai Publications 2001-316845 and 2001-516810. Such a metal surface treating agent comprising a zirconium compound has an excellent property compared with such a chemical conversion treating agent comprising zinc phosphate as described above, in that the formation of sludge is inhibited.

But, when the surface of metal for vehicle chassis is treated with the above mentioned metal surface treating agent, it was difficult to form chemical conversion coats having adequate adhesion of a coat and adequate post-coating corrosion resistance.

### SUMMARY OF THE INVENTION

In view of the above state of the art, it is an object of the present invention to provide a pretreatment method for coating the surface of metal for vehicle chassis, in which a phosphorus element is not essential, the formation of sludge is extremely small, waste water treatment is facilitated, and a chemical conversion coat having adequate adhesion and adequate corrosion resistance can be formed.

The present invention relates to a pretreatment method for coating a surface of metal for vehicle chassis comprising treating the surface of metal for vehicle chassis with a chemical conversion treating solution to form a chemical conversion coat,

wherein said chemical conversion treating solution comprises zirconium in an amount of 50 to 500 ppm on the metal element equivalent basis, and at least one silane compound selected from the group consisting of γ-aminopropyltriethoxysilane, hydrolysates of γ-aminopropyltriethoxysilane, γ-aminopropyltrimethoxysilane and hydrolysates of γ-aminopropyltrimethoxysilane; and has a pH of 2 to 6.

Preferably, the above chemical conversion treating solution comprises γ-aminopropyltriethoxysilane, hydrolysates of γ-aminopropyltriethoxysilane, γ-aminopropyltrimethoxysilane or hydrolysates of γ-aminopropyltrimethoxysilane in an amount-of 50 to 500 ppm.

Preferably, the above chemical conversion treating solution further comprises 50 to 500 ppm of magnesium ions and/or 50 to 1000 ppm of zinc ions.

Preferably, the pretreatment is carried out at a temperature of the chemical conversion of 30 to 60° C. and with a treatment time of 30 to 300 seconds.

Preferably, a surface conditioning step is omitted prior to the chemical conversion treatment.

The present invention also relates to a method of applying a powder coating composition, comprising:

a step of (1) treating an article to be treated by the pretreatment method for coating the surface of metal for vehicle chassis according to any one of claims 1 to 5; and

a step of (2) powder coating the article treated in the step (1).

### DETAILED DESCRIPTION OF THE INVENTION

Hereinafter, the present invention will be described in detail.

The present invention relates to a pretreatment method for coating comprising treating the surface of metal for vehicle chassis with a chemical conversion treating solution to form a chemical conversion coat on it, and the above chemical conversion treating solution comprises zirconium in an amount of 50 to 500 ppm on the metal element equivalent basis, and at least one silane compound selected from the group consisting of γ-aminopropyltriethoxysilane, hydrolysates of γ-aminopropyltriethoxysilane, γ-aminopropyltrimethoxysilane and hydrolysates of γ-aminopropyltrimethoxysilane; and has a pH of 2 to 6. Therefore, in the pretreatment method for coating of the present invention, a phosphorus element is not essential in the solution and the formation of sludge is extremely small, and which facilitates waste water treatment. And, it is possible to form a coat having good adhesion and good corrosion resistance without a surface conditioning step.

In the pretreatment method for coating the surface of metal for vehicle chassis of the present invention, by bringing, for example, a shot blasted hot rolled steel plate or the like into contact with a weakly acidic aqueous solution of fluorozirconic acid, Fe²⁺ ion is eluted due to an etching reaction at an anode portion and a pH at an interface increases due to a reduction reaction of hydrogen at a cathode portion to precipitate hydroxide of zirconium. At the anode portion, the eluted Fe²⁺ ion catches fluorine in a complex fluorine ion of ZrF₆⁻, and thereby hydroxide of zirconium is precipitated similarly. The coat of the precipitated zirconium hydroxide is a closely packed amorphous coat and this coat can inhibit the permeation of water or chlorine ions to protect the corrosion of metal. A silanol group of aminosilane reacts through dehydration condensation with hydroxyl group of zirconium hydroxide precipitated on the surface of metal to form a metalloxan bond. It is considered that an amino group of aminosilane is oriented to the direction of the coating film and forms a strong chemical bond by reacting with a functional group of the coating film, and thereby the adhesion to the coating film is enhanced. The chemical conversion treatment coat thus formed by the pretreatment method for coating of the present invention can have performance which is equal to or higher than the conventional zinc phosphate coat from the viewpoint of both the corrosion resistance and the adhesion of a coat.

The pretreatment method for coating the surface of metal for vehicle chassis of the present invention is a pretreatment method for coating, in which the surface of metal for vehicle chassis is treated with a chemical conversion treating solution to form a chemical conversion coat on it. Thereby, a corrosion prevention property can be given to the steel sheets.

As the above surface of metal for vehicle chassis, there can be give the surface of steel lumber modified by a surface oxidation such as hot rolling, cold rolling or the like; the surface of steel lumber from which a modified layer such as mill scale or the like is removed by shot blasting or the like; and the surface of lumber of high tensile aluminum alloys of Al—Cu and Al—Zn—Mg, corrosion resistible aluminum alloys of Al—Mg, Al—Si, and Al—Si—Mg, alumite, brass, bronze, zinc-plated, tin-plated, nickel-plated and chromium-plated surfaces, and the like, by means of immersion plating or electroplating.

The above chemical conversion treating solution comprises zirconium in an amount of 50 to 500 ppm on the metal element equivalent basis, and at least one silane compound selected from the group consisting of γ-aminopropyltriethoxysilane, hydrolysates of γ-aminopropyltriethoxysilane, γ-aminopropyltrimethoxysilane, and hydrolysates of γ-aminopropyltrimethoxysilane.

The above chemical conversion treating solution comprises zirconium in an amount within the range from a lower limit of 50 ppm to an upper limit of 500 ppm on the metal element equivalent basis. When the content of zirconium is less than 50 ppm, the formation of a coat is insufficient and the corrosion resistance is also be insufficient. When it is more than 500 ppm, an additional effect cannot be expected and it is economically unfavorable. The above content is more preferably 75 to 300 ppm.

A resource of the above zirconium is not particularly limited and for example, alkali metal fluorozirconates such as K₂ZrF₆ and the like; fluorozirconates such as (NH₄)₂ZrF₆ and the like; soluble fluorozirconates such as fluorozirconic acid, e.g. H₂ZrF₆, and the like; zirconium fluoride; and zirconium oxide, and the like can be given. Among others, fluorozirconic acid (H₂ZrF₆) and ammonium fluorozirconates ((NH₄)₂ZrF₆) are preferred because of their no influences on the chemical conversion properties.

The above chemical conversion treating solution also comprises at least one silane compound selected from the group consisting of γ-aminopropyltriethoxysilane, hydrolysates of γ-aminopropyltriethoxysilane, γ-aminopropyltrimethoxysilane and hydrolysates of γ-aminopropyltrimethoxysilane. The above silane compounds are compounds having at least one amino group in its molecule and having a siloxane bond. These compounds act on both the chemical conversion coat and the coating film, and thereby the adhesion between the chemical conversion coat and the coating film is improved.

As the above hydrolysates, there are given substances produced by hydrolysis of the above γ-aminopropyltriethoxysilane or γ-aminopropyltrimethoxysilane, and hydrolysis condensates formed by condensation of the produced substances.

The above chemical conversion treating solution preferably comprises γ-aminopropyltriethoxysilane, hydrolysates of γ-aminopropyltriethoxysilane, γ-aminopropyltrimethoxysilane or hydrolysates of γ-aminopropyltrimethoxysilane in an amount of 50 to 500 ppm. When this content is less than 50 ppm, the formation of a coat may be insufficient and the corrosion resistance may also be insufficient. When it is more than 500 ppm, an additional effect cannot be expected and it may be economically unfavorable. The above content is more preferably 75 to 300 ppm.

As a commercially available product of the above γ-aminopropyltriethoxysilane, there can be given KBE-903 (trade name, produced by Shin-Etsu Chemical Co., Ltd.), Sila-Ace S-330 (trade name, produced by CHISSO-CORPORATION), and the like.

As a commercially available product of the above 7-aminopropyltrimethoxysilane, there can be given KBM-903 (trade name, produced by Shin-Etsu Chemical Co., Ltd.), Sila-Ace S-360 (trade name, produced by CHISSO CORPORATION), and the like.

Preferably, the above chemical conversion treating solution further comprises magnesium ions. If comprising the magnesium ions, a chemical conversion coat having better adhesion and better corrosion resistance can be obtained. The content of the above magnesium ions preferably has a lower limit of 50 ppm and an upper limit of 500 ppm. When this content is less than 50 ppm, the formation of a coat may be insufficient and the corrosion resistance may also be insufficient. When it is more than 500 ppm, an additional effect cannot be expected and it is economically unfavorable. The above content is more preferably 75 to 400 ppm.

As a resource of the above magnesium ion, there can be given magnesium nitrate, magnesium sulfate, magnesium carbonate and the like.

Preferably, the above chemical conversion treating solution further comprises zinc ions. If comprising the above zinc ions, a chemical conversion coat having better adhesion and better corrosion resistance can be obtained. The content of the zinc ions preferably has a lower limit of 50 ppm and an upper limit of 1000 ppm. When this content is less than 50 ppm, the formation of a coat may be insufficient and the corrosion resistance may also be insufficient. When it is more than 1000 ppm, an additional effect cannot be expected and it is economically unfavorable. The content is more preferably 100 to 750 ppm.

As a source of the above zinc ion, there can be given zinc nitrate, zinc sulfate, zinc carbonate and the like.

The above chemical conversion treating solution has a pH of 2 (a lower limit) to 6 (an upper limit) When the pH is lower than 2, etching becomes excessive and the formation of a coat cannot be adequately achieved. When the pH is higher than 6, etching becomes insufficient and a good coat is not obtained. The pH lower limit is more preferably 2.5.and the pH upper limit is more preferably 5.0.

In order to adjust the pH of the chemical conversion treating solution, acidic compounds such as nitric acid, sulfuric acid and the like, and basic compounds such as sodium hydroxide, potassium hydroxide, ammonia and the like can be used.

Preferably, the above chemical conversion treating solution does not substantially comprise phosphate ions. “Not substantially comprising phosphate ions,” means that phosphate ions are not contained to such an extent that they act as a component in the chemical conversion treating solution. Since the chemical conversion treating solution used in the present invention does not substantially contain phosphate ions, phosphorous resulting in an environmental burden may not be substantially used and the formation of a sludge such as iron phosphate, zinc phosphate and the like, which are produced in using a zinc phosphate treating agent, can be inhibited.

As the above chemical conversion treating solution, an arbitrary component may be used in combination, as required, in addition to the above components. As a component which can be used, there can be given silica and the like. By adding such a component in the solution, it is possible to improve the post-coating corrosion resistance.

Chemical conversion treatment in the pretreatment method for coating of the present invention is not particularly limited and can be performed by bringing an article to be treated such as a hot rolled steel plate or the like into contact with the chemical conversion treating solution on the ordinary treatment conditions, and the like. A method of conversion treatment is not particularly limited and for example, an immersion step, spraying, roll coating and the like can be given.

With respect to the conditions of chemical conversion treatment, the treatment is preferably carried out at a temperature of 30 to 60° C. When it is lower than 30° C., since a chemical reactivity is low and a coat cannot be formed adequately, the corrosion resistance may be poor. When it is higher than 60° C., an additional effect cannot be expected and it is uneconomical. More preferably, the above treatment is carried out at a temperature of 35 to 50° C. The treatment is preferably carried out with a treatment time of 30 to 300 seconds. When it is less than 30 seconds, a coat cannot be formed adequately and the corrosion resistance may be poor. When it is more than 300 seconds, an additional effect cannot be expected and it may be uneconomical. The above treatment is more preferably carried out with a treatment time of 45 to 240 seconds.

A amount of a chemical conversion coat obtained by the pretreatment method for coating of the present invention is preferably within the limits that a lower limit is 5 mg/m² and an upper limit is 300 mg/m² in terms of the total amount of the metals contained in the chemical conversion treating solution. When the amount of a chemical conversion coat is less than 5 mg/m², the obtained chemical conversion coat is not uniform and it is not preferred. When it is more than300 mg/m², an additional effect cannot be obtained and it is economically unfavorable. The above lower limit is more preferably 10 mg/m² and the above upper limit is more preferably 200 mg/m².

In the pretreatment method for coating the surface of metal for vehicle chassis of the present invention, a surface conditioning step can be omitted prior to the above conversion treatment.

In the conventional treatment with phosphate solution, the surface conditioning step was required after alkaline degreasing and rinsing with water, but in the pretreatment method for coating the surface of metal for vehicle chassis of the present invention, the above surface conditioning step was not required after alkaline degreasing and rinsing with water, and a coat having the good adhesion of coating and the good corrosion resistance can be obtained by less steps.

The above alkaline degreasing is a degreasing step for removing an oil adhering to the surface of a steel sheet and the like, and in this step, immersion treatment is generally performed at 30 to 55° C. for several minutes with an alkaline degreasing cleaning solution and/or a phosphorus- and nitrogen-free degreasing cleaning solution. It is also possible to perform pre-degreasing prior to the above degreasing treatment as desired. After alkaline degreasing, post-degreasing rinsing is carried out by spraying a large amount of rinsing water one or more times to rinse the above degreasing agent.

Also, the pretreatment method for coating of the present invention is preferably a method comprising rising with water, drying or air blowing, and powder coating after the above chemical conversion treatment.

In the present invention, if rinsing with water after the above chemical conversion treatment is insufficient, this badly affects film appearance in the following powder coating, and therefore the steel sheet is rinsed with water two times or more after the conversion treatment. In this case, it is appropriate to perform the final rinsing with pure water. A temperature of the above pure water is preferably 20 to 80° C.

The method of the present invention is also preferred in that all steps from alkali degreasing to rinsing with pure water after the chemical conversion treatment can be performed by either spray water rinsing or immersion water rinsing. Therefore, the method of the present invention can be carried out by using existing equipments.

Preferably, drying or air blowing is carried out after rinsing with water after the above chemical conversion treatment. Drying or air blowing is preferably carried out at a room temperature to a temperature of 120° C. A drying time is preferably 5 seconds to 10 minutes.

Powder-coating after drying can be carried out by a method of normal powder coating, and include, for example, a method comprising: applying powder coating composition to the surface of an article to be coated by electrostatic spray coating, fluidized bed dip coating or the like; heating the powder coating composition on the surface of the coated article to be melted and cured; and cooling the article, and the like.

The above powder coating composition is not particularly limited and for example, a substance in which an epoxy resin, an acrylic resin, a polyester resin or the like is used as a main binder and a curing agent such as polyhydric carboxylic acid, blocked isocyanate or the like is blended as required, and the like can be given.

A method of applying a powder coating composition, comprising the steps of (1) treating an article to be treated by the pretreatment method for coating the surface of metal for vehicle chassis described above, and (2) powder coating the article treated in the step (1), also constitutes the present invention. As described above, rinsing with water and drying may be performed between the step (1) and the step (2), as required.

The pretreatment method for coating the surface of metal for vehicle chassis of the present invention is a method of forming a chemical conversion coat by treating the surface of metal for vehicle chassis with a chemical conversion treating solution comprising specific amounts of specific components, and a burden on the environment is small because the above chemical conversion treating solution does not contain a phosphorus element, and the formation of sludge is extremely small and waste water treatment is facilitated.

The pretreatment method for coating the surface of metal for vehicle chassis of the present invention can reduce the step of a line because the surface conditioning step, which is required in the conventional zinc phosphate treatment process, is not required in the method, and form a treated coat having post-coating performance (the adhesion of coating and the corrosion resistance) of which is equal to or higher than the conventional zinc phosphate coats.

Since the pretreatment method for coating the surface of metal for vehicle chassis of the present invention has a constitution described above, a phosphorus element is not essential, the formation of sludge is extremely small, and waste water treatment can be facilitated. This method can form a treated coat having post-coating performance (the adhesion of coating and the corrosion resistance) of which is equal to or higher than the conventional zinc phosphate coat without the surface conditioning step. Therefore, it can be suitably employed as a pretreatment method for coating the surface of metal for vehicle chassis.

### BEST MODES FOR CARRYING OUT THE INVENTION

Hereinafter, the present invention will be described in detail by way of Examples, but the present invention is not limited to these Examples. Further, “part(s)” or “%” refers to “part(s) by weight” or “% by weight”, respectively.

Preparation for Chemical Conversion Treating Solution of Example 1

H₂ZrF₆ (200 ppm as Zr) was dissolved in water, thereto were added Mg (NO₃)₂ (200 ppm as Mg) and Zn(NO₃)₂ (500 ppm as Zn), and finally a required amount of γ-APS (γ-aminopropyltriethoxysilane) was added and stirred thoroughly, and the obtained solution was adjusted to a pH 4.0 with ammonia water.

### EXAMPLE 1

A shot blasted hot rolled steel plate (70 mm×150 mm×5 mm, produced by Nippon Testpanel Co., Ltd.) was cleaned at 42° C. for 2 minutes with an alkaline degreasing agent (SURFCLEANER EC92, produced by NIPPON PAINT Co., Ltd.), rinsed with water, and treated at 40° C. for 90 seconds with the chemical conversion treating solution of Example 1. Then, the sheet was rinsed with water and further rinsed with pure water of 60° C., and then it was airblown to dry. Then, a powder coating composition (Powdax P200 black, a polyester powder coating composition produced by NIPPON PAINT Co., Ltd.) was applied on the sheet by electrostatic spraying and baked by keeping at 160° C. for 20 minutes so as to obtain a film thickness of 50 mm on the sheet.

### EXAMPLES 2 TO 6, COMPARATIVE EXAMPLES 1 TO 3

Chemical conversion treatment of the steel sheets was carried out by the same procedure as in Example 1 except for changing the concentrations of the components of the chemical conversion treating solution and the temperature and the treatment time of the conversion treatment to values shown in Table 1. Then, the obtained steel sheets were rinsed with water, dried, and powder-coated.

### COMPARATIVE EXAMPLE 4

Same material as used in Example 1 was cleaned with an alkaline degreasing agent, rinsed with water, surface-treated by being immersed in a surface conditioner (SURFFINE 5N-8R, produced by NIPPON PAINT Co., Ltd.) at room temperature for 30 seconds, and then immersed in a conventional zinc phosphate treating agent (SURFDINE SD5350, produced by NIPPON PAINT Co., Ltd.) at 35° C. for 2 minutes. Then, it was rinsed with water, dried, and powder-coated in the same procedure as in Example 1.

(Evaluation Method)

Salt Spray Test (SST)

After a cross-cut (10 cm×10 cm) was made in the surface of the powder-coated sheet with a cutter, the sheet was treated at 35° C. for 360 hours by spraying a 5% aqueous solution of NaCl. Then, the width of rust formed on both sides of a cut portion was measured and was evaluated according to the following criteria. The results of evaluation are shown in Table 1.
O: the width of rust is less than 5 mm

33 : the width of rust is 5 mm or more

TABLE 1

| | | Zr | Mg | Zn | | | | |
|---|---|---|---|---|---|---|---|---|
| | | concentration | concentration | concentration | γ-APS | Temperature | Time | SST |
| | | (ppm) | (ppm) | (ppm) | (ppm) | (° C.) | (sec) | performance |
| Example | 1 | 200 | 200 | 500 | 200 | 40 | 90 | ∘ |
| | 2 | 60 | 400 | 250 | 60 | 45 | 90 | ∘ |
| | 3 | 450 | 60 | 900 | 450 | 35 | 40 | ∘ |
| | 4 | 100 | 100 | 200 | 100 | 55 | 35 | ∘ |
| | 5 | 150 | 100 | 60 | 100 | 35 | 280 | ∘ |
| | 6 | 200 | 200 | 400 | 200 | 40 | 60 | ∘ |
| Comparative | 1 | 30 | 30 | 30 | 30 | 40 | 120 | x |
| Example | 2 | 60 | 30 | 30 | 40 | 40 | 25 | x |
| | 3 | 100 | 100 | 100 | 100 | 25 | 60 | x |

| | | |
|---|---|---|
| 4 | treated with zinc phosphate | ∘ |

From Table 1, it was found that the treated articles to which the treatment of the present invention was applied exhibited-the good corrosion resistances, but the treated articles to which the treatment of Comparative Example was applied had the poor corrosion resistances. The treated articles to which the treatment of the present invention was applied had the corrosion resistances, which were equal to or higher than the treated article (Comparative Example 4) treated with conventional zinc phosphate, without being subjected to the surface conditioning step.

### INDUSTRIAL APPLICABILITY

The present invention can be suitably applied as the pretreatment method for coating the surface of metal for vehicle chassis, which facilitates waste water treatment and can form a coat having good adhesion and good corrosion resistance without the surface conditioning step.

1. A pretreatment method for coating a surface of metal for vehicle chassis comprising treating the surface of metal for vehicle chassis with a chemical conversion treating solution to form a chemical conversion coat,
wherein said chemical conversion treating solution comprises zirconium in an amount of 50 to 500 ppm on the metal element equivalent basis, and at least one silane compound selected from the group consisting of γ-aminopropyltriethoxysilane, hydrolysates of γ-aminopropyltriethoxysilane, γ-aminopropyltrimethoxysilane and hydrolysates of γ-aminopropyltrimethoxysilane; and has a pH of 2 to 6.

2. The pretreatment method for coating a surface of metal for vehicle chassis according to claim 1,
wherein the chemical conversion treating solution comprises γ-aminopropyltriethoxysilane, hydrolysates of γ-aminopropyltriethoxysilane, γ-aminopropyltrimethoxysilane or hydrolysates of γ-aminopropyltrimethoxysilane in an amount of 50 to 500 ppm.

3. The pretreatment method for coating the surface of metal for vehicle chassis according to claim 1,
wherein the chemical conversion treating solution further comprises 50 to 500 ppm of magnesium ions and/or 50 to 1000 ppm of zinc ions.

4. The pretreatment method for coating the surface of metal for vehicle chassis according to claim 1,
wherein the pretreatment is carried out at a temperature of the chemical conversion of 30 to 60° C. and with a treatment time of 30 to 300 seconds.

5. The pretreatment method for coating the surface of metal for vehicle chassis according to claim 1,
wherein a surface conditioning step is omitted prior to the chemical conversion treatment.

6. A method of applying a powder coating composition, comprising:
a step of (1) treating an article to be treated by the pretreatment method for coating the surface of metal for vehicle chassis according to claim 1; and
a step of (2) powder coating the article treated in the step (1).

7. The pretreatment method for coating the surface of metal for vehicle chassis according to claim 2,
wherein the chemical conversion treating solution further comprises 50 to 500 ppm of magnesium ions and/or 50 to 1000 ppm of zinc ions.

8. The pretreatment method for coating the surface of metal for vehicle chassis according to claim 2,
wherein the pretreatment is carried out at a temperature of the chemical conversion of 30 to 60° C. and with a treatment time of 30 to 300 seconds.

9. The pretreatment method for coating the surface of metal for vehicle chassis according to claim 3,
wherein the pretreatment is carried out at a temperature of the chemical conversion of 30 to 60° C. and with a treatment time of 30 to 300 seconds.

10. The pretreatment method for coating the surface of metal for vehicle chassis according to claim 2,
wherein a surface conditioning step is omitted prior to the chemical conversion treatment.

11. The pretreatment method for coating the surface of metal for vehicle chassis according to claim 3,
wherein a surface conditioning step is omitted prior to the chemical conversion treatment.

12. The pretreatment method for coating the surface of metal for vehicle chassis according to claim 4,
wherein a surface conditioning step is omitted prior to the chemical conversion treatment.

13. A method of applying a powder coating composition, comprising:
a step of (1) treating an article to be treated by the pretreatment method for coating the surface of metal for vehicle chassis according to claim 2; and
a step of (2) powder coating the article treated in the step (1).

14. A method of applying a powder coating composition, comprising:
a step of (1) treating an article to be treated by the pretreatment method for coating the surface of metal for vehicle chassis according to claim 3; and
a step of (2) powder coating the article treated in the step (1).

15. A method of applying a powder coating composition, comprising:
a step of (1) treating an article to be treated by the pretreatment method for coating the surface of metal for vehicle chassis according to claim 4; and
a step of (2) powder coating the article treated in the step (1).

16. A method of applying a powder coating composition, comprising:
a step of (1) treating an article to be treated by the pretreatment method for coating the surface of metal for vehicle chassis according to claim 5; and
a step of (2) powder coating the article treated in the step (1).
